(19) United States
(12) Patent Application Publication
(10) Pub. No.: US 2026/0200460 A1
(43) Pub. Date: Jul. 16, 2026

(54) VEHICLE CONTROL DEVICE AND VEHICLE CONTROL METHOD

(71) Applicant: TOYOTA JIDOSHA KABUSHIKI KAISHA, Toyota-shi (JP)

(72) Inventors: Shun YAMANE, Toyota-shi (JP); Takashi Saito, Fuji-shi (JP)

(73) Assignee: TOYOTA JIDOSHA KABUSHIKI KAISHA, Toyota-shi (JP)

(21) Appl. No.: 19/391,442

(22) Filed: Nov. 17, 2025

(30) Foreign Application Priority Data
Jan. 14, 2025 (JP) 2025-004795

(51) Int. Cl. B60W 30/02; A63F 13/57; A63F 13/803

(52) U.S. Cl. CPC B60W 30/02; A63F 13/57; A63F 13/803

(57) ABSTRACT

A vehicle control device comprises: an acquirer that acquires play information of a game played by an occupant of a vehicle, and a controller that drives one of a front wheel side active stabilizer device and a rear wheel side active stabilizer device whose sway of a vehicle body relative to power consumption is larger, in accordance with the acquired play information.

### REFERENCE TO RELATED APPLICATIONS

This application is based upon and claims the benefit of priority from the prior Japanese Patent Application No. 2025-004795 filed on Jan. 14, 2025, the entire contents of which are incorporated herein by reference.

### BACKGROUND

### 1. Technical Field

The present disclosure relates to technology for controlling active stabilizer devices mounted on vehicles.

### 2. Background Information

JP 2021-113046 discloses an active suspension system provided in series or parallel with an air suspension system between a vehicle wheel and a vehicle body. The active suspension system is used to induce certain motions in the vehicle when playing video games. These motions are induced in response to pre-recorded motion tracking associated with audio or video recordings, or in response to commands given by the video game player in the car using controller inputs.

The technology disclosed in JP 2021-113046 may consume too much power due to driving the active suspension.

### SUMMARY

The purpose of the present disclosure is to provide a technique for reducing power consumption of an active stabilizer device driven according to play information of a game.

A vehicle control device according to one embodiment comprises: an acquirer that acquires play information of a game played by an occupant of a vehicle, and a controller that drives one of a front wheel side active stabilizer device and a rear wheel side active stabilizer device whose sway of a vehicle body relative to power consumption is larger, in accordance with the acquired play information.

Another embodiment is a vehicle control method comprising: acquiring play information of a game played by an occupant of the vehicle; and driving one of a front wheel side active stabilizer device and a rear wheel side active stabilizer device whose sway of a vehicle body relative to power consumption is larger, in accordance with the acquired play information.

### BRIEF DESCRIPTION OF THE DRAWINGS

FIG. 1 shows the functional configuration of the example vehicle control system.

FIG. 2 is a diagram of a vehicle equipped with an active stabilizer system.

FIG. 3A and FIG. 3B illustrates the relationship between the output torque T of the active stabilizer device and the input F to the vehicle body.

FIG. 4 shows a comparison of the power consumption of the active stabilizer device between actual driving control and game time control.

### DETAILED DESCRIPTION

The invention will now be described by reference to the preferred embodiments. This does not intend to limit the scope of the present invention, but to exemplify the invention.

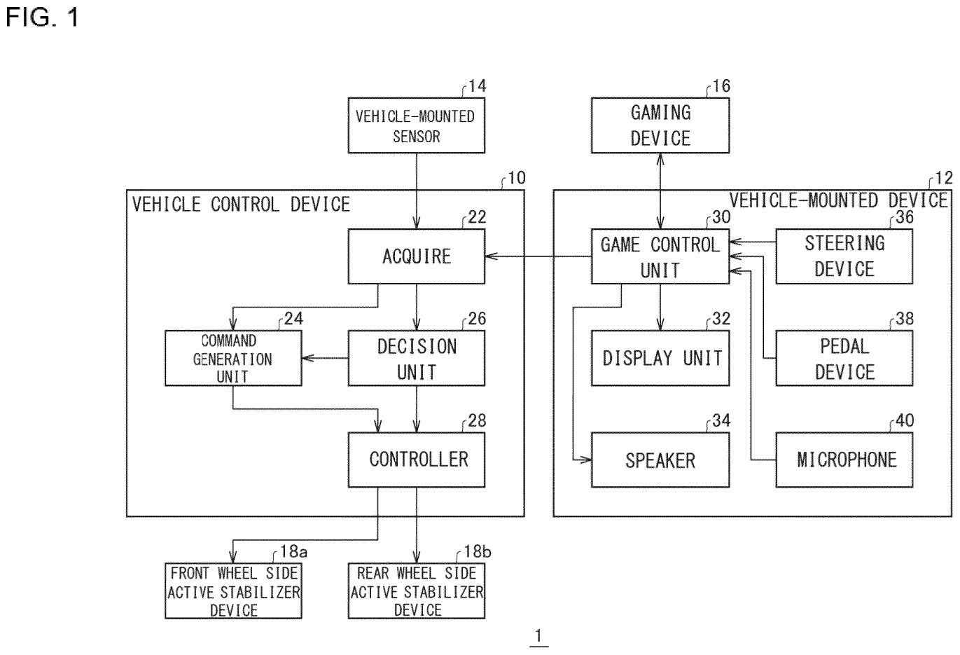

FIG. 1 shows the embodiment of the invention. FIG. 1 shows the functional structure of the example vehicle control system 1. In FIG. 1, each element described as a functional block that performs various processes can be composed of circuit blocks, memory, and other LSIs in terms of hardware, and in terms of software, they are realized by programs loaded into memory, etc. Therefore, it is understood by those skilled in the art that these functional blocks can be realized in various ways by hardware alone, software alone, or a combination thereof, and are not limited to any of them.

The vehicle control system 1 includes a vehicle control device 10, an vehicle-mounted device 12, an vehicle-mounted sensor 14, a gaming device 16, a front wheel side active stabilizer device 18a and a rear wheel side active stabilizer device 18b. The vehicle control system 1 may be installed in a vehicle having an automatic driving function that can drive autonomously.

The vehicle control system 1 allows occupants to play games in the vehicle using the in-vehicle device 12. While the occupants are playing the game, the vehicle is stationary. The vehicle control system 10 controls the front wheel side active stabilizer device 18a and the rear wheel side active stabilizer device 18b (when these are not distinguished, “active stabilizer device 18”) according to the game playing state to execute a control to shake the vehicle body. This can bring a sense of realism to the game to the occupants.

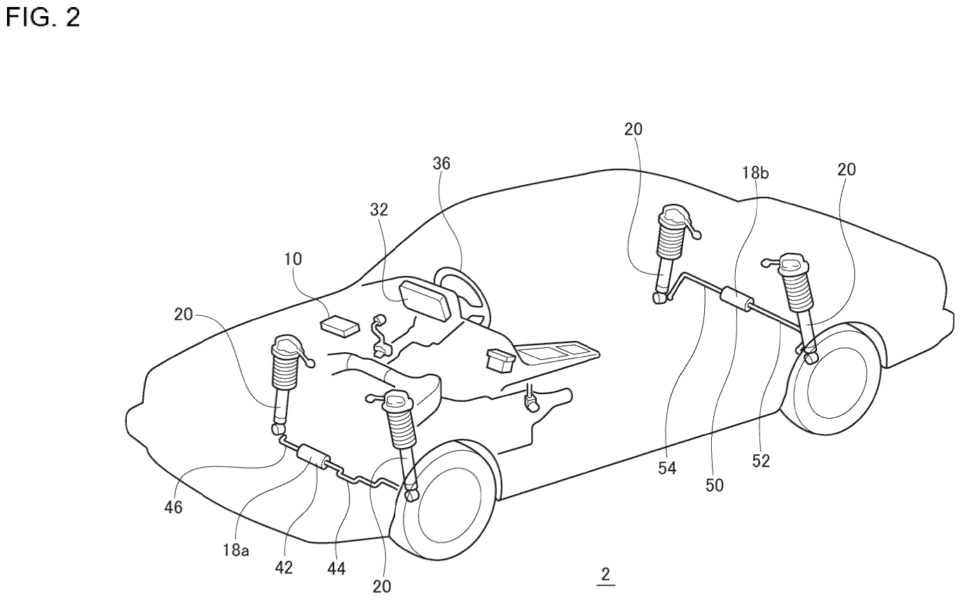

FIG. 2 is a diagram of a vehicle 2 equipped with an active stabilizer device 18. The suspension device 20 is positioned between the wheels and the vehicle body and generates damping force for inputs from the wheels and the vehicle body. The suspension device 20 is located on the left front wheel, right front wheel, left rear wheel, and right rear wheel, respectively.

The active stabilizer device 18 has a front wheel side active stabilizer device 18a disposed on the front wheel side and a rear wheel side active stabilizer device 18b disposed on the rear wheel side. The active stabilizer device 18 is connected at both ends to the left and right wheel support structures, e.g., lower arms.

The front wheel side active stabilizer device 18a has a right stabilizer bar 46, a left stabilizer bar 44, and an actuator 42 that connects the right stabilizer bar 46 and the left stabilizer bar 44 for relative rotation. The vehicle control device 10 can drive the actuator 42 to rotate the right stabilizer bar 46 and the left stabilizer bar 44 relative to each other to apply roll direction force to the vehicle body.

The rear wheel side active stabilizer device 18b, like the front wheel side active stabilizer device 18a, has a right stabilizer bar 54, a left stabilizer bar 52, and an actuator 50. The shapes of the stabilizer bars of the front wheel side active stabilizer device 18a and the rear wheel side active stabilizer device 18b are different.

The active stabilizer device 18 is used to control the roll direction movement of the vehicle body, but in the example, it is used to sway the vehicle body in the roll direction, etc.

Return to FIG. 1. The in-vehicle sensors 14 include sensors that detect the amount of drive of the actuators 42 and 50, sensors that detect the stopping of the vehicle, and the like. The in-vehicle sensors 14 send the detection results to the vehicle control device 10.

The gaming device 16 is an external device not mounted in the vehicle 2 and includes AR glasses, VR headsets, external displays, game controllers, speakers and vibration devices. The gaming device 16 is wired or wirelessly connected to the in-vehicle device 12 and sends and receives information while playing a game. The game device 16 may include a game console body and send and receive information to and from the vehicle control device 10. The game console itself may be a smartphone.

The in-vehicle device 12 has a game control unit 30, a display unit 32, a speaker 34, a steering device 36, a pedal device 38, and a microphone 40. The display unit 32 may be, for example, a display in a center console, a display in a passenger seat or rear seat, or an instrument panel, or a combination thereof. Display 32 and speaker 34 function as game output devices and output images and sounds received from game control unit 30. The game output device may further include at least one of the following: an air conditioning device, a seat vibration device, and a haptic pedal. The active stabilizer device 18 also functions as one of the game output devices.

The steering device 36, pedal device 38 and microphone 40 function as game input devices. The steering device 36 sends the rudder angle and rudder angle speed to the game control unit 30. The pedal device 38 sends the accelerator pedal and brake pedal operation amounts to the game control unit 30, respectively. Microphone 40 detects sounds, including the voice of the occupants, and sends them to game control unit 30. The game input devices may be changed depending on the type of game. For example, the steering device 36 and pedal device 38 are used when running a game in which vehicles are raced.

The game control unit 30 holds a plurality of programs for games, generates play results in response to instructions from the game input devices, and sends them to the game output devices. The game control unit 30 sends play information to the vehicle control device 10 indicating that the game is being executed. The game control unit 30 can communicate wirelessly with an external game server device and may send instruction information from the game input device to the server device and receive play results from the server device. The play results may include images and sounds.

The play information may include information indicating that a game is being played, information requesting the active stabilizer device 18 to be driven, and information regarding a target drive amount of the active stabilizer device 18. For example, the game control unit 30 requests driving of the active stabilizer device 18 when a racing game or an action game is being played. For example, the information regarding the target drive amount of the active stabilizer device 18 includes information indicating the movement of the vehicle in the game, and includes information indicating the vehicle's speed, steering angle, acceleration, and collision.

The vehicle control device 10 has an acquisition unit 22, a command generation unit 24, a decision unit 26, and a controller 28. The acquisition unit 22 acquires play information for games played using the in-vehicle device 12 or games played using the game device 16. In either case, the play information is generated by being executed by the occupants in the vehicle.

The decision unit 26 determines to drive the active stabilizer device 18 according to the acquired game play information. The decision unit 26 decides to drive the one of the front wheel side active stabilizer device 18a and the rear wheel side active stabilizer device 18b, which has a larger sway of the vehicle body relative to the power consumption. This allows the power consumption for shaking the vehicle body to be reduced.

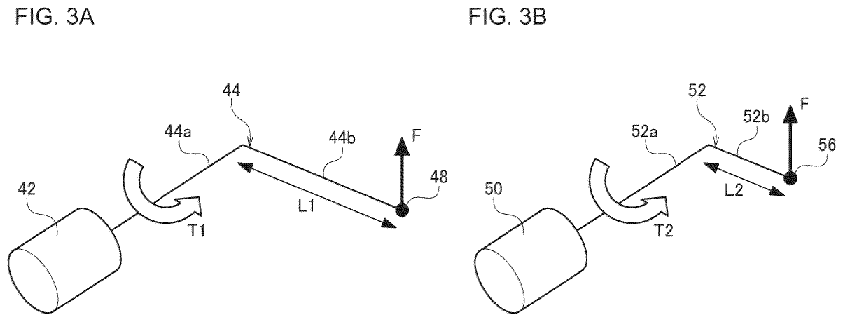

FIG. 3 illustrates the relationship between the output torque T of the active stabilizer device 18 and the input F to the vehicle body. FIG. 3A shows a schematic diagram of the actuator 42 and left stabilizer bar 44 of the front wheel side active stabilizer device 18a, and FIG. 3B shows a schematic diagram of the actuator 50 and left stabilizer bar 52 of the rear wheel side active stabilizer device 18b.

The left stabilizer bar 44 shown in FIG. 3A is divided into a rotation axis direction component 44a along the rotation axis of the actuator 42 and a radial direction component 44b orthogonal to the rotation axis. The arm length L1 of the radial component 44b is set longer. The end of the left stabilizer bar 44 is connected to the lower arm or the like at the connection position 48.

The left stabilizer bar 52 shown in FIG. 3B is divided into a rotation axis direction component 52a along the rotation axis of the actuator 50 and a radial direction component 52b orthogonal to the rotation axis. The arm length L2 of the radial component 52b is shorter than the arm length L1 of the left stabilizer bar 44. The end of the left stabilizer bar 52 is connected to the lower arm or the like at the connection position 56.

If the input F to the vehicle body at the coupling position 48 and the input F to the vehicle body at the coupling position 56 are the same, the output torque T1 of the actuator 42 is greater than the output torque T2 of the actuator 50. Since the output torque is proportional to power, the greater the output torque, the greater the power consumption. The magnitude of the electric power supplied to the actuator 42 varies with the current value, assuming that the voltage is rated. Therefore, the torque output by the actuator 42 changes according to the magnitude of the current value supplied to the actuator 42. The arm length of the radial component in the stabilizer bar is one of the factors that define the power consumption when the active stabilizer system 18 shakes the vehicle body.

The magnitude of the shaking of the car body in relation to the power consumption of the active stabilizer device 18 also varies depending on the positional relationship between the active stabilizer device 18, the coil springs of the suspension system 20, and the tires. Formula 1 below shows the relationship between the input F of the active stabilizer device 18 and the amount of tire stroke δ. Formula 1 is calculated by the equation relating the amount of stroke of the tire δ and the amount of stroke of the coil spring, and the equation showing the balance of the moment of the coil spring and the moment of the active stabilizer device 18.

$$δ = F {D}_{2} {D}_{3} \text{/k} {D}_{1}^{2} \qquad Formula 1$$

D₁, D₂, and D₃ are all distances on the support structure extending from the tires to the vehicle body. D₁ is the distance from the connection position of the active stabilizer device 18 to the vehicle body. D₂ is the distance from the connection position of the coil spring in the suspension system 20 to the vehicle body. “k” is the spring constant of the coil spring. D₃ is the distance from the tire to the vehicle body. The connection position of the active stabilizer device 18 and the connection position of the coil spring are located on the distance D₃ from the tire to the vehicle body.

The amount of tire stroke δ shown in Formula 1 is the sway of the vehicle body. The amount of stroke δ of the tire is inversely proportional to the square of the distance D₁ of the active stabilizer device 18 to the input F of the active stabilizer device 18 and proportional to the distance D₂ of the coil spring and D₃ of the tire. The longer the distance D₁ of the active stabilizer device 18, the smaller the sway of the vehicle body, and the longer the distance D₂ of the coil spring and D₃ of the tire, the larger the sway of the vehicle body. Thus, the magnitude of the vehicle body sway is determined by the arm length of the radial component of the active stabilizer device 18, the distance D₁ from the connection position of the active stabilizer device 18 to the vehicle body, the distance D₂ from the connection position of the coil spring to the vehicle body, and the distance D₃ from the tire to the vehicle body, and other factors D₃.

Return to FIG. 1. The decision unit 26 determines which active stabilizer device 18 should be driven during game play based on the priority order of the front wheel side active stabilizer device 18a and the rear wheel side active stabilizer device 18b. The priorities of the front wheel side active stabilizer device 18a and the rear wheel side active stabilizer device 18b are set in advance by experimenting with the magnitude of the vehicle body sway in response to power consumption, etc., and are maintained in the memory of the vehicle control device 10. The magnitude of the vehicle body sway may be, for example, the amount of stroke of the vehicle body in the three-dimensional direction, or the amount of stroke in the roll direction.

The decision unit 26 decides to preferentially drive the active stabilizer device 18 that has a greater amount of vehicle body sway relative to power consumption during game play. The decision unit 26 decides to drive the front wheel side active stabilizer device 18a and the rear wheel side active stabilizer device 18b, which has a larger sway of the vehicle body with respect to power consumption, according to the acquired play information. This allows the power consumption to be suppressed and efficiently bring a sense of realism of the game to the occupants. The decision unit 26 sends the decision result to the controller 28.

The command generation section 24 generates command values to the active stabilizer device 18 to shake the vehicle body in conjunction with the game play status based on the play information. For example, if a vehicle racing game is being played and the vehicle in the game turns, the command generator 24 generates command values to tilt the actual vehicle body. The command generator 24 generates command values to make the actual vehicle shake according to the information indicating the movement of the vehicle in the game included in the play information.

The controller 28 controls the active stabilizer device 18 according to the command values of the command generation unit 24 and the decision results of the decision unit 26. The controller 28 may comprise a plurality of electronic control units (ECUs), and may comprise an ECU that controls the front wheel side active stabilizer device 18a, an ECU that controls the rear wheel side active stabilizer device 18b, an ECU that controls the suspension device 20.

The controller 28 drives the one of the front wheel side active stabilizer device 18a and the rear wheel side active stabilizer device 18b that has a larger sway of the vehicle body relative to the power consumption according to the acquired play information. This allows the vehicle body to sway efficiently to bring a sense of realism to the occupants in the game.

The controller 28 drives only the rear wheel side active stabilizer device 18b according to the acquired play information. When the front wheel side active stabilizer device 18a is configured to more easily suppress roll direction movement in response to inputs from the wheels and vehicle body than the rear wheel side active stabilizer device 18b, it may be less efficient when the inputs are reversed to the vehicle body. Therefore, the controller 28 can reduce power consumption by driving only the rear wheel side active stabilizer device 18b, which is more efficient.

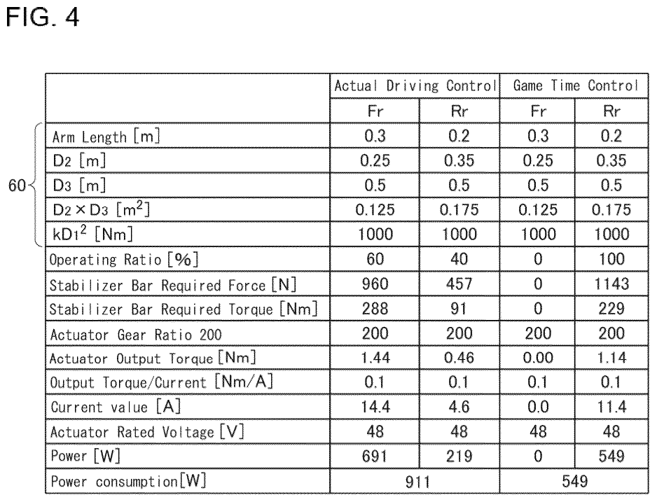

FIG. 4 shows a comparison of the power consumption of the active stabilizer device 18 between actual driving control and game time control. The 60 structural elements of the active stabilizer device 18 shown in FIG. 4 represent a predefined example and vary from car model to car model.

The arm length of the radial component of the front wheel side active stabilizer device 18a is longer than that of the rear wheel side active stabilizer device 18b. The distance D₃ between the tire and the vehicle body is the same. The distance D₂ between the suspension system 20 and the vehicle body is longer for the rear wheel side active stabilizer device 18b. This allows the rear wheel side active stabilizer device 18b to sway the vehicle body more efficiently than the front wheel side active stabilizer device 18a.

In actual driving control, the operation ratio of the front wheel side active stabilizer device 18a is 60 percent and that of the rear wheel side active stabilizer device 18 b is 40 percent. This is because in actual driving control, the front wheel side roll stiffness is distributed so that the front wheel side roll stiffness is higher than the rear wheel side roll stiffness to prevent unstable behavior of the vehicle.

On the other hand, in game time, since the distribution of front wheel side roll stiffness and rear wheel side roll stiffness is unnecessary, only the rear wheel side roll stiffness can be increased. Therefore, the operation ratio of the rear wheel side active stabilizer device 18 b, which is more efficient in transmission to the vehicle body, is 100 percent. This reduces the power consumption of game control compared to actual driving control.

The control unit 28 may not only drive the active stabilizer device 18 according to the play information, but also the suspension device 20. In this case, the suspension device 20 is an active suspension device that can be extended or retracted under the control of the controller 28.

The determining unit 26 may change the drive of the active stabilizer device 18 according to the charge rate of the power supply unit feeding the active stabilizer device 18. The acquiring unit 22 acquires information indicating the charging rate of the power supply device feeding the active stabilizer device 18. The decision unit 26 decides to drive both the front wheel side active stabilizer device 18a and the rear wheel side active stabilizer device 18b if the acquired charge rate of the power supply device is above a predetermined value, for example 70 percent or more. If the obtained charge rate of the power supply unit is smaller than the predetermined value, the decision unit 26 decides to drive the one of the front wheel side active stabilizer device 18a and the rear wheel side active stabilizer device 18b whose vehicle body sway relative to power consumption is larger. The controller 28 controls the active stabilizer device 18, receiving the result of the decision by the decision unit 26.

It is understood by those skilled in the art that the examples are examples only and that various variations in the combination of each component element are possible and that such variations are also within the scope of the present disclosure.

1. A vehicle control device comprising:
an acquirer that acquires play information of a game played by an occupant of a vehicle, and
a controller that drives one of a front wheel side active stabilizer device and a rear wheel side active stabilizer device whose sway of a vehicle body relative to power consumption is larger, in accordance with the acquired play information.

2. The vehicle control device according to claim 1,
wherein the controller drives only the rear wheel side active stabilizer device in accordance with the acquired play information.

3. The vehicle control device according to claim 1,
Wherein the acquirer acquires play information of a game that is executed using an in-vehicle device mounted on the vehicle.

4. A vehicle control method in which each step is performed by a vehicle control device mounted on a vehicle, the vehicle control method comprising:
acquiring play information of a game played by an occupant of the vehicle; and
driving one of a front wheel side active stabilizer device and a rear wheel side active stabilizer device whose sway of a vehicle body relative to power consumption is larger, in accordance with the acquired play information.
